(19) United States
(12) Patent Application Publication
(10) Pub. No.: US 2008/0248866 A1
(43) Pub. Date: Oct. 9, 2008

(54) Projection Apparatus for Use With a Gaming System

(76) Inventor: James Cove, Worcestershire (GB)

Correspondence Address: GREENBLUM & BERNSTEIN, P.L.C., 1950 ROLAND CLARKE PLACE, RESTON, VA, 20191, US

(21) Appl. No.: 11/993,749

(22) PCT Filed: Jun. 30, 2006
(86) PCT No.: PCT/GB06/02454

§ 371 Date: May 5, 2008

(30) Foreign Application Priority Data
Jul. 1, 2005 (GB) 0513361.6

(51) Int. Cl. A63F 9/24; A63F 13/00

(52) U.S. Cl. 463/25; 463/31

(57) ABSTRACT

A projection apparatus (7) is for use with a gaming system to provide a game with an outcome. The apparatus (7) projects an image of the game onto a projection surface which may be a table or specific sheet or panel. The image may include player-input means which enable a player to interact with the image in addition to graphics, animation and text representing the game. The apparatus (7) preferably comprises an integrated unit with a control unit (8) and a projector (9). The control unit (8) may be connected to a gaming device (1) in the system for two-way communication therewith.

The invention relates to a projection apparatus and more particularly, to a projection apparatus for use with a gaming system with a video display and an input means providing a gambling game.

A gaming system may have at least one gaming device with a display, and an input means. The input means is usually in the form of a control panel with buttons for use during a game, or a keyboard and/or mouse and often the display is a video display. Once the gaming device has been actuated, usually by a predetermined amount of credit, which may be a stake value, a game can be played on the device, e.g. poker, roulette, etc. During a game, a player has a visual representation of a game on the video display and interaction with the game using the input means.

It is known to provide a gaming system with a gaming device which is linked to a remote server, for providing the data for a game or games.

It is also known to provide a projection of a gaming area onto a projection screen for the purpose of increasing the size of the view of a gaming area to a player and surrounding observers, to aid tactical play of a game, as in U.S. Pat. No. 5,480,158. U.S. Pat. No. 5,480,158 discloses a player-operable gaming system which has a gaming device with a game area thereon and a video recording device positioned in front of the gaming device which is connected to a projector. A video image of the gaming device is projected onto a vertical projection screen, which is out-of-sight of the gaming device to increase the view of the gaming area for the benefit of the player. An input means in the form of a control panel having a plurality of push buttons, is located on a stand-alone console in front of the projection screen. However, the console is connected to the out-of-sight gaming device and the operation of the gaming device effects changes in the video image of the device which is seen on the projection screen in front of the console.

It is known to provide a projected display of a game to give a more realistic experience in game playing. U.S. Pat. No. 5,552,839 relates to a player-operable gaming system, which has a gaming device in the form of a PC connected to a projection system, for projection of a video display from the PC onto a curved projection screen. A player can sit in front of the screen to view the projected video image on the curved screen which gives a more realistic 3D representation of the game to a player.

An object of the present invention is to provide a projection apparatus for use with a gaming system, to present a changing projected image of a gambling game to enhance entertainment by providing a more realistic gambling experience.

According to a first aspect of the invention therefore there is provided a projection apparatus, for use with a gaming system which provides a credit-actuated game involving a stake and having an outcome, characterised in that the projection apparatus projects an image of a game onto a level projection surface.

With this arrangement a player is presented with a projected visual display of a gambling game e.g. roulette, poker, bingo, keno, onto a level surface, to increase the entertainment value, by providing a realistic representation of a gambling game played in a casino environment.

The level surface may be a horizontal or substantially horizontal or inclined surface such as an existing table or desk top, or a specially provided sheet or panel which may be rigid or flexible and also which may be shaped or planar and which may be plain or marked with decoration and/or indications which may accompany or form part of the game.

A second object of the present invention is to provide a projection apparatus for use with a gaming system with a changing display of a gambling game and a changing interactive input means, providing a more realistic representation of a gambling game.

According to a second aspect of the invention therefore which may be combined with the first aspect, there is provided a projection apparatus, for use with a gaming system which provides a credit-actuated game involving a stake and having an outcome, wherein the projection apparatus projects an image of a game onto a surface, characterised in that interactive player input means are also projected by the projection apparatus.

With this arrangement a player can also interact directly with the projected input means and therefore the gambling game, to place a bet, pick up a card, mark a number etc., to increase the entertainment value further and provide a casino-like environment.

Preferably, the projection apparatus comprises a control unit for connection to a gaming device via a connection means, and a projector. Most preferably, the control unit, connection means and projector are provided in an integrated unit. The connection means may comprise a USB connector or a serial connector for two-way communication between the gaming device and the control unit.

The control unit may also comprise software for processing and relaying of a digital signal from a gaming device to the projector, to direct the projection of the image onto the level surface. The projected image preferably comprises graphics, animations and text to provide a representation of a game. The game may be a gambling game, for example, roulette, poker, blackjack, keno, bingo etc. Preferably, the image is changeable to reflect a particular stage of a game.

The projector may be a digital projector which may be a micromirror projector, i.e. a Texas Instruments' Digital Light Processing apparatus, or an LCD projector, i.e. JVC Image Light Amplifier.

A player may interact directly with the projected image by provision of a sensor for detecting interaction of a player with the image, i.e. by a player's finger or a wand. In this case, the video image may comprise betting means for selecting the details of a bet, i.e. stake value and placing of a bet. The control unit may comprise software for calculating the location of the interaction by a player.

The sensor is most preferably provided in the integrated unit.

The sensor may be a laser sensor, i.e. Keyance LV-H47. Alternatively, the sensor may comprise a touch screen or pad sensor connected to the control unit of the projection apparatus for detecting selection of the details of the bet.

According to a third aspect of the invention there is provided a gaming system incorporating a projection apparatus as described above.

A fourth object of the present invention is to provide a player-operable gaming apparatus with a changing display and wherein a game is provided by a remote link to a network.

According to a fourth aspect of the invention therefore which may be combined with the third aspect, there is provided a player-operable gaming system which is credit-actuated and involves a stake, having a changing display and an outcome, wherein the display is projected by a gaming device having a projection apparatus which projects an image of a game onto a surface, characterised in that the game is provided via a link between the gaming device and a remote gaming server.

This enables the gaming device to play a game provided e.g. over the internet by a remote server, e.g. from a server providing a gambling website.

The gaming device may comprise a microprocessor-based processing unit, a display apparatus and an input means, i.e. a PC with a monitor, keyboard and/or mouse and CPU.

The processing unit preferably has a web browser and connection software and be connected to the remote gaming server, provided by a communication link. The communication link may be a dial-up link using a modem and a telephone line, a hard wire connection, a network connection or a combination of the above.

The control unit of the projection apparatus is most preferably connected to the processing unit of the gaming device, for two-way communication therebetween, via the communication means.

A gaming session may be activated by connecting to the remote server using the communication link and providing credit to the remote server. This may be done by providing credit card or bank details using the display apparatus and input means of the gaming device. The remote server may provide a plurality of gambling games for selection by a player.

The gaming server most preferably provides game information data to the processing unit of the gaming device which communicates with the control unit for projection of the image of the game.

The invention will now be described further by way of example only and with reference to the accompanying drawing in which:

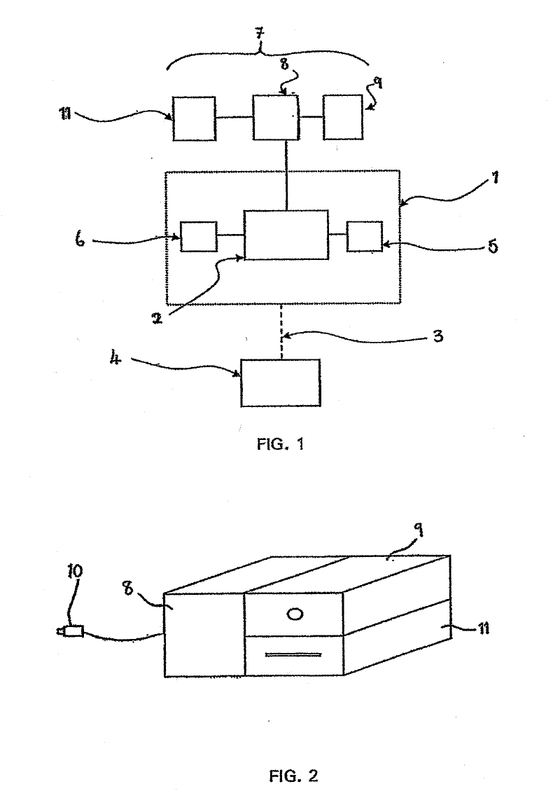

FIG. 1 a diagrammatic block circuit diagram of a gaming system; and

FIG. 2 a perspective diagrammatic view of a projection apparatus according to FIG. 1.

As shown in FIG. 1, a gaming system comprises a gaming device 1 with a microprocessor-based processing unit 2, connected by a communication link 3 to a central gaming server 4, at a remote location from the gaming device 1. The communication link 3 may be a remote dial-up link using a modem and a telephone line, hard-wire connection or network connection or combination of the above. The gaming server provides game information data via communication link 3 to the gaming device 1.

The gaming device 1, which is a PC, comprises a display apparatus 5 connected to the microprocessor-based processing unit 2, in the form of a monitor, and an input means 6 in the form of a keyboard and/or mouse.

The changing display is provided by a projected image from a digital projection apparatus 7 which can be connected to the processing unit 2 and comprises a control unit 8 connected to a projector 9, a connection means 10 for connection of the control unit 8 with the processing unit 2 of the gaming device 1 and a sensor 11. The control unit 8 comprises software for receiving and processing a digital signal from the processing unit 2, via connection means which then relays the signal to the projector 9, for projection of the image onto a projection surface.

The projector 9 may be a micromirror projector e.g. Texas Instruments' Digital Light. Processing (DLP) line, which forms images using microscopic mirrors. In this case, the projector comprises a high-power lamp, a prism and a semiconductor chip. The semiconductor chip is covered in more than a million mirrors, each with a hinge forming an array of microscopic mirrors (Digital Micromirror Device (DMD)).

The lamp shines light through the prism, which then splits the light into component colours red, green and blue. Each colour beam then hits a different mirror on the semiconductor chip. Depending on the information in the signal from the control unit, the semiconductor turns the mirrors on their hinges to reflect the coloured beams to create a monochromatic image, which is then reflected back to the prism. The prism recombines the colours to form a full colour image, which is projected on to the projection surface.

Alternatively, the projector 9 may be an LCD projector e.g. JVC Digital Image Light Amplifier (D-ILA) line. In this case, the projector comprises a mirror covered with an LCD display and a lamp. The liquid crystals in the display are affected by electric current which can be used to twist the liquid crystals in the display, which twist predictably in response to the application of a particular voltage.

The lamp shines high-intensity light onto the mirror with the LCD. Dependent on the digital signal i.e. the voltage received from the control unit 8, the crystals may twist so that some of the liquid crystals let light reflected off of the mirror through and others block it, to create an image on the projection surface.

The connection means 10 on the control unit 8 may terminate in a USB or serial connector for interaction with a USB port or serial port of the processing unit 2.

The projector 9 is calibrated by the control unit 8, to project the image onto projection surface 12. A “keystone correction”, also directed by the control unit 8 may also necessary to ensure the correct perspective is presented to a player on the projection surface.

The image comprises graphics and/or animations and/or text to provide the display of a gambling game, e.g. roulette, poker, blackjack, keno etc., on the projection surface. The image is changeable according to the stage of a game and/or type of game being played. For example, an image of a roulette wheel, or poker cards may be projected onto the projection surface.

Means for placing a bet, is also provided on the image, i.e. in the case of roulette, by the provision of a betting table indicating the numbers of the roulette wheel and betting quantities e.g. £1, £5, etc., which can be selected by contacting the projection surface with a player's finger or other instrument, such as a wand. In the case of poker, a player may select the cards that he/she wishes to retain or change by touching the relevant card, with a finger or wand.

The interaction of a player with the image by touching of a particular card, in the case of poker, is detected by the sensor 11, which relays the information back to the control unit 8.

The sensor 8 may be a laser sensor, provided as part of the projection apparatus, of the Area Detection, Definite-reflective Laser Sensor type, i.e. Keyence LV-H47, which enables a laser to be emitted over a wide area and detects objects in the path of the laser by detecting reflected laser beams.

The laser sensor 11 directs laser beams parallel with and at a distance just above the projection surface and image. The interaction of the player with the image i.e. by a finger or other instrument such as a wand causes interruption of some of the laser beams, at which point the beams are reflected back to the sensor 11. The sensor 11 communicates the information to the control unit 8.

Alternatively, a touch screen or sensor pad connected to the control unit 8 of the projection apparatus, may be provided as the projection surface. In this case, the interaction of the player with the image i.e. by a finger or other instrument, causes a signal to be sent to the control unit 8.

The control unit 8 comprises software for processing the information sent from the sensor 11 in conjunction with the digital signal provided by the processing unit 2 producing the projection, to calculate the location on the image that was interacted with. The information can then be communicated to the processing unit 2 to determine the action that was taken by the player. The action of the player is then communicated to the remote gaming server 4 via communication link 3.

In use, a player can activate a session of gaming by providing credit e.g. by credit card details or bank account details, to a remote server hosting a gambling website, using the PC monitor, mouse and keyboard. Once the credit conditions have been satisfied, the player can select a particular game for play, i.e. roulette.

Once a game has been selected, data comprising the image details of the game, is sent from the remote server 4 to the processing unit 2 of the PC. The PC communicates with the control unit 8 of the projection apparatus 7, which provides a signal the projector for display of the image of the game on the projection surface. The image presents an initial representation of the game, with graphics, text and animations. A player can then place a bet on the game using the interactive input means provided by the image i.e. selection of a roulette number and stake value, and detected by the sensor 11. The details of the bet is communicated back to the remote server 4 for registration of the bet and deduction of the stake value from the player's credit. The registration of the bet triggers the remote server 4 to provide an outcome for game. In the case of roulette, the remote server 4 may communicate data involving a moving image for projection to represent spinning of the roulette wheel. The bet details are then assessed against the resultant outcome of the game and the outcome is displayed to the player on the image, with the results of the win/loss. Further play may be allowed, dependent on the player's credit, with the provision of options to “continue” or “collect” buttons as part of the projected image.

At the end of a game, or end of a series of games, when the player's credit is no longer sufficient for play of a game, the player may be given to option to provide more credit, or terminate the game. Alternatively, a player may terminate a game and choose an alternative game, i.e. poker. Where a player chooses to terminate a game, data of the game is no longer communicated to the projection apparatus and the image disappears, until a game is once again activated.

It is of course to be understood that the invention is not intended to be restricted to the details of the above embodiment, which are described by way of example only.

1-27. (canceled)

28. A projection apparatus for use with a gaming system which provides a credit-actuated game involving a stake and having an outcome, comprising projection apparatus which projects an image of said game onto a level projection surface.

29. The projection apparatus of claim 28, wherein the level surface is a horizontal or substantially horizontal or inclined surface.

30. The projection apparatus of claim 28, wherein the level surface is a specially provided sheet or panel.

31. The projection apparatus of claim 30, wherein the sheet or panel is flexible and is shaped.

32. The projection apparatus of claim 30, wherein the sheet or panel comprises indications which accompanies or forms part of the game.

33. The projection apparatus of claim 28, wherein interactive player input means are also projected by the apparatus.

34. A projection apparatus, for use with a gaming system comprising a credit-actuated game involving a stake and having an outcome, wherein the projection apparatus projects an image of said game onto a surface, wherein interactive player input means are also projected by the projection apparatus.

35. The projection apparatus of claim 28, wherein the projection apparatus comprises a control unit for connection to a gaming device via a connection means, and a projector.

36. The projection apparatus of claim 35, wherein the control unit, connection means and projector are provided in an integrated unit.

37. The projection apparatus of claim 35, wherein the connection means comprises a USB connector or a serial connector for two-way communication between the gaming device and the control unit.

38. The projection apparatus of claim 35, wherein the control unit comprises software for processing and relaying of a digital signal from a gaming device to the projector, to direct the projection of the image onto the level surface.

39. The projection apparatus of claim 28, wherein the projected image comprises graphics, animations and text to provide a representation of a game.

40. The projection apparatus of claim 28, wherein the image is changeable to reflect a particular stage of a game.

41. The projection apparatus of claim 28, wherein the projector is a digital projector.

42. The projection apparatus of claim 28, wherein a sensor is provided for detecting interaction of a player with the image.

43. The projection apparatus of claim 42, wherein the video image comprises betting means for selecting stake value and placing of a bet.

44. The projection apparatus of claim 42, wherein a control unit comprises software for calculating the location of the interaction by a player.

45. The projection apparatus of claim 42, wherein the projection apparatus comprises a control unit for connection to a gaming device via a connection means, and a projector, the control unit, connection means, projector, and sensor being provided in an integrated unit.

46. The projection apparatus of claim 45, wherein the sensor comprises a touch screen or pad sensor connected to the control unit of the projection apparatus for detecting selection of the details of a bet.

47. A gaming system incorporating a projection apparatus as claimed in claim 28.

48. The gaming system of claim 47, wherein the gaming system is player-operable, credit-actuated and involves a stake, having a changing display and an outcome, wherein the display is projected by a gaming device having the projection apparatus which projects an image of a game onto a surface, wherein the game is provided via a link between the gaming device and a remote gaming server.

49. A player-operable gaming system which is credit-actuated and involves a stake, the system comprising a changing display and an outcome, wherein the display is projected by a gaming device having a projection apparatus which projects an image of a game onto a surface, the game being provided via a link between the gaming device and a remote gaming server.

50. The gaming system according to claim 47, the projection apparatus comprises a control unit for connection to a gaming device via a connection means, and a projector, said gaming device comprising a microprocessor-based processing unit, a display apparatus and an input means.

51. The gaming system according to claim 50, wherein the processing unit has a web browser and connection software and is connected to a remote gaming server, provided by a communication link.

52. The gaming system according to claim 50, wherein a control unit of the projection apparatus is connected to the processing unit of the gaming device, for two-way communication therebetween, via a communication link.

53. The gaming system according to claim 52, wherein a gaming server provides game information data to the processing unit of the gaming device which communicates with the control unit for projection of the image of the game.
